(19) United States
(12) Patent Application Publication
(10) Pub. No.: US 2025/0242550 A1
(43) Pub. Date: Jul. 31, 2025

(54) METHOD OF MANUFACTURING FIBER REINFORCED RESIN MOLDED ARTICLE, FIBER REINFORCED RESIN MOLDED ARTICLE MANUFACTURING SYSTEM, AND FIBER REINFORCED RESIN MOLDED ARTICLE

(71) Applicants: Tatsuki YAMAGUCHI, Kanagawa (JP); Satoyuki SEKIGUCHI, Kanagawa (JP); Yusuke KOMINE, Kanagawa (JP); Yuuma USUI, Kanagawa (JP); Soyoung PARK, Kanagawa (JP)

(72) Inventors: Tatsuki YAMAGUCHI, Kanagawa (JP); Satoyuki SEKIGUCHI, Kanagawa (JP); Yusuke KOMINE, Kanagawa (JP); Yuuma USUI, Kanagawa (JP); Soyoung PARK, Kanagawa (JP)

(21) Appl. No.: 19/015,685

(22) Filed: Jan. 10, 2025

(30) Foreign Application Priority Data
Jan. 30, 2024 (JP) 2024-012299

(51) Int. Cl. B29C 70/18; B29C 70/00; B29C 70/30; B29K 77/00; B29K 307/04; B29K 309/08; C08K 5/5419

(52) U.S. Cl. CPC B29C 70/18; B29C 70/003; B29C 70/30; C08K 5/5419; B29K 2077/00; B29K 2307/04; B29K 2309/08

(57) ABSTRACT

A method of manufacturing a fiber reinforced resin molded article is provided. The method includes: patterning a fiber sheet with an ink including a soft resin composition that at least comprises a soft material; applying a matrix resin onto the patterned fiber sheet to obtain a fiber reinforced resin composite; and molding the fiber reinforced resin composite to obtain a fiber reinforced resin molded article. An interior of the fiber sheet in the fiber reinforced resin molded article is filled with the soft material and the matrix resin.

### CROSS-REFERENCE TO RELATED APPLICATION

This patent application is based on and claims priority pursuant to 35 U.S.C. § 119 (a) to Japanese Patent Application No. 2024-012299, filed on Jan. 30, 2024, in the Japan Patent Office, the entire disclosure of which is hereby incorporated by reference herein.

### BACKGROUND

### Technical Field

The present disclosure relates to a method of manufacturing a fiber reinforced resin molded article, a fiber reinforced resin molded article manufacturing system, and a fiber reinforced resin molded article.

### Related Art

Fiber reinforced resin molded articles are lightweight and strong. As a result, fiber reinforced resin molded articles are used in the aerospace industry, in mobility devices such as automobiles, and in sporting equipment. Although fiber reinforced resin molded articles have excellent strength, cracking can sometimes be problematic, and there have been issues in improving the impact resistance. Therefore, a technique has been proposed in which a fiber reinforced resin molded article and a soft material having excellent impact resistance are combined to achieve both a high strength and impact resistance.

### SUMMARY

Embodiments of the present invention provide a method of manufacturing a fiber reinforced resin molded article. The method includes patterning a fiber sheet with an ink including a soft resin composition that at least comprises a soft material, applying a matrix resin onto the patterned fiber sheet to obtain a fiber reinforced resin composite, and molding the fiber reinforced resin composite to obtain a fiber reinforced resin molded article. An interior of the fiber sheet in the fiber reinforced resin molded article is filled with the soft material and the matrix resin.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a flowchart illustrating a method of manufacturing a fiber reinforced resin molded article according to an embodiment of the present invention;

FIG. 2 is a schematic diagram illustrating a fiber reinforced resin molded article manufacturing system according to an embodiment of the present invention; and

FIG. 3 is a schematic diagram illustrating a change before and after a molding step in a method of manufacturing a fiber reinforced resin molded article according to an embodiment of the present invention.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to embodiments of the present invention, a method of manufacturing a fiber reinforced resin molded article having a high degree of design freedom is provided.

A method of manufacturing a fiber reinforced resin molded article according to an embodiment of the present invention includes a patterning step for patterning a fiber sheet with an ink including a soft resin composition that at least comprises a soft material, an application step for applying a matrix resin onto the patterned fiber sheet to obtain a fiber reinforced resin composite, a molding step for molding the fiber reinforced resin composite to obtain a fiber reinforced resin molded article, and other additional steps if preferable.

Examples of other steps include a drying step for drying the fiber sheet before performing the application step, and a lamination step for laminating the fiber reinforced resin composite in a plurality of layers.

A fiber reinforced resin molded article manufacturing system according to an embodiment of the present invention includes a patterning device that performs the patterning step, a drying device that performs the drying step, an application device that performs the application step, a lamination device that performs the lamination step, a molding device that performs the molding step, and other additional devices if preferable.

The method of manufacturing a fiber reinforced resin molded article according to an embodiment of the present invention can be preferably implemented by the fiber reinforced resin molded article manufacturing system according to an embodiment of the present invention, in which the patterning step can be performed by the patterning device, the drying step can be performed by the drying device, the application step can be performed by the application device, the lamination step can be performed by the lamination device, and the molding step can be performed by the molding device.

Note that, in the present disclosure, the term “fiber reinforced resin composite” refers to a composite in which a soft resin composition that at least comprises a soft material, and a matrix resin have been applied onto a fiber sheet. Furthermore, the fiber reinforced resin composite includes a laminate obtained by laminating the fiber reinforced resin composite in a plurality of layers in the lamination step. The term “fiber reinforced resin molded article” refers to an article obtained by molding the fiber reinforced resin composite.

Hereinafter, embodiments of the present invention will be described in detail with reference to the drawings.

### (Method of Manufacturing Fiber Reinforced Resin Molded Article)

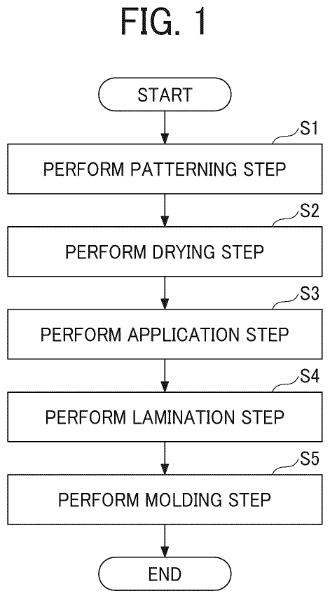

FIG. 1 is a flowchart illustrating a method of manufacturing a fiber reinforced resin molded article according to an embodiment of the present invention.

The method of manufacturing a fiber reinforced resin molded article according to an embodiment of the present invention includes a patterning step S1, a drying step S2, an application step S3, a lamination step S4, and a molding step S5, in this order.

### <Patterning Step>

In the patterning step S1, a fiber sheet is patterned with an ink including a soft resin composition that at least comprises a soft material. In the patterning step S1, a region impregnated with the ink is adjusted, in other words, a pattern arrangement is adjusted, to adjust the physical properties, such as the strength and impact resistance, of the fiber reinforced resin molded article.

The patterning method is not particularly limited and can be selected as appropriate according to the intended purpose, as long as the method is capable of impregnating the fiber sheet with the ink. For example, the ink may be ejected onto the fiber sheet by an inkjet nozzle, or the ink may be manually applied onto the fiber sheet.

The pattern arrangement may be a regular pattern arrangement in which the fiber sheet is impregnated with the ink in a regular manner, or an irregular pattern arrangement in which the fiber sheet is impregnated with the ink in an irregular manner. For example, a pattern may be formed only on a center portion on the fiber sheet, or only on both ends on the fiber sheet. Examples of the regular pattern arrangement include, but are not limited to, a stripe pattern and a lattice pattern.

### [Soft Resin Composition]

The soft resin composition at least comprises a soft material. Further, the soft resin composition includes a crosslinking agent, a chain transfer agent, an emulsifier, a polymerization initiator, a solvent, and other components if preferable. For example, the soft resin composition is preferably a resin emulsion, the resin emulsion being a dispersion of resin particles in an aqueous medium. The resin particles are solid or liquid. The aqueous medium includes, as a solvent, water or a hydrophilic solvent as the main component, and may also include both water and a hydrophilic solvent.

### —Soft Material—

The soft material is a material that improves the impact resistance of the fiber reinforced resin molded article. For example, the soft material is resin particles.

The resin particles are not particularly limited and can be selected as appropriate according to the intended purpose. Examples of the resin particles include, but are not limited to, acrylic resin particles, polyester resin particles, urethane acrylic resin particles, silicone resin particles, vinyl acetate acrylic resin particles, polyurethane resin particles, and polyester resin particles. Among such resin particles, acrylic resin particles are preferable from the viewpoint of the degree of design freedom. Examples of the acrylic resin particles include, but are not limited to, resin particles formed of acrylic acid esters, methacrylic acid esters, aromatic vinyl monomers, unsaturated nitriles, conjugated diolefins, polyfunctional vinyl monomers, amide monomers, hydroxyl group-containing monomers, caprolactone addition monomers, amino group-containing monomers, glycidyl group-containing monomers, acid monomers, and vinyl monomers. Furthermore, examples of the acrylic ester resin particles include, but are not limited to, resin particles formed of methyl methacrylate, 2-ethylhexyl acrylate, butyl acrylate, hexyl acrylate, and 2-ethylhexyl acrylate. Examples of the polyester resin particles include, but are not limited to, resin particles formed of polyethylene terephthalate and 1,6-hexanediol dimethacrylate. The soft material may be formed using a single type of resin particle or a combination of two or more types of resin particles.

### —Crosslinking Agent—

The crosslinking agent reacts with the soft material, and causes the soft material to polymerize with itself to form a crosslinked structure. The crosslinking agent improves the strength of the fiber reinforced resin molded article. In the present disclosure, the crosslinking agent does not react with the soft material until the molding step. The crosslinked structure is formed as a result of the crosslinking reaction proceeding due to the heat and pressure applied in the molding step.

The type of crosslinking agent is not particularly limited, and can be selected as appropriate according to the intended purpose. However, an alkoxysilane crosslinking agent is preferable in that, when preparing the soft resin composition, a non-crosslinked state can be maintained until the molding step by adjusting the pH.

The type of alkoxysilane crosslinking agent is not particularly limited, and can be selected as appropriate according to the intended purpose. Examples thereof include, but are not limited to, vinyltriethoxysilane and vinyltrimethoxysilane. Among such alkoxysilane crosslinking agents, vinyltriethoxysilane and vinyltrimethoxysilane are preferable from the viewpoint of the degree of design freedom. These alkoxysilane crosslinking agents may be used alone, or as a combination of two or more.

The content of the crosslinking agent is preferably 3% by mass or more and 15% by mass or less, and more preferably 5% by mass or more and 10% by mass or less with respect to the total amount of the soft resin composition. A content of the crosslinking agent of 5% by mass or more and 10% by mass or less is preferable in that it is possible to achieve both a high degree of filling properties of the interior of the fiber sheet with the soft material, and strength of the resulting fiber reinforced resin molded article.

### —Chain Transfer Agent—

The chain transfer agent adjusts the molecular weight of the resulting polymer. The chain transfer agent is not particularly limited, and examples thereof include, but are not limited to, mercaptoacetic acid, mercaptopropionic acid, 2-propanethiol, 2-mercaptoethanol, thiophenol, dodecyl mercaptan, 1-dodecanethiol, and thioglycerol. A single type of chain transfer agent may be used alone, or a combination of two or more types of chain transfer agents may be used. Furthermore, the chain transfer agent is preferably included in an amount of 1 to 30 parts by mass relative to the total amount of the ink.

### —Emulsifier—

The emulsifier is not particularly limited, and a non-reactive emulsifier or a reactive emulsifier can be used. However, it is preferable to use a reactive emulsifier. The use of a reactive emulsifier improves the storage stability of the ink. The reactive emulsifier is not particularly limited, and can be appropriately selected according to the intended purpose. However, it is particularly preferable to use an emulsifier having a radically polymerizable double bond. Examples of the reactive emulsifier include, but are not limited to, an aqueous solution of polyoxyethylene nonylpropenyl phenyl ether ammonium sulfate, and sodium alkanesulfonate. A single type of emulsifier may be used alone, or two or more types of emulsifiers may be used together. In addition, the emulsifier is preferably included in an amount of 1 to 30 parts by mass relative to the total amount of the ink.

### —Polymerization Initiator—

The polymerization initiator starts the polymerization of the soft material. As the polymerization initiator, a radical polymerization initiator, a cationic polymerization initiator, or an anionic polymerization initiator can be used. However, it is preferable to use a radical polymerization initiator. The use of a polymerization initiator improves the dispersion stability. In order to obtain a sufficient polymerization rate, the polymerization initiator is preferably included in an amount of 1 to 30 parts by mass relative to the total amount of the ink.

Examples of the radical polymerization initiator include, but are not limited to, an aqueous ammonium persulfate solution, aromatic ketones, acylphosphine oxide compounds, aromatic onium salt compounds, organic peroxides, thio compounds (such as thioxanthone compounds and thiophenyl group-containing compounds), hexaarylbiimidazole compounds, ketoxime ester compounds, borate compounds, azinium compounds, metallocene compounds, active ester compounds, compounds having a carbon-halogen bond, alkylamine compounds, azo compounds, and hexaarylbiimidazole.

Examples of the cationic polymerization initiator include, but are not limited to, photoacid generators that generate an acid by being irradiated with light. Examples thereof include, but are not limited to, onium salt-type initiators having a sulfonium ion or an iodonium ion as the cation moiety, and triarylsulfonium salt-type initiators.

Example of the anionic polymerization initiator include, but are not limited to, photobase generators that generate a base by being irradiated with light. Photobase generators include ionic-type generators that generate a strong base, and nonionic-type generators that have excellent dissolution stability.

A single type of polymerization initiator may be used alone, or two or more types of polymerization initiators may be used together.

### [Fiber Sheet]

The fiber sheet is a sheet including fibers, and is molded into a flat shape.

The type of fiber is not particularly limited, and can be appropriately selected according to the intended purpose. Examples of the fiber include, but are not limited to glass fiber, carbon fiber, boron fiber, and aramid fiber. Among such fibers, glass fiber or carbon fiber is preferable from the viewpoint of improving the strength of the fiber reinforced resin molded article. As the fiber included in the fiber sheet, a single type of fiber may be used alone, or two or more types of fibers may be used in combination.

### [Ink]

The ink includes a soft resin composition and a solvent, and further includes other components if preferable.

The solvent included in the ink is preferably includes water and an organic solvent.

### —Organic Solvent—

The organic solvent is not particularly limited, and a water-soluble organic solvent can be used. Examples of the organic solvent include, but are not limited to, polyhydric alcohols, ethers such as polyhydric alcohol alkyl ethers and polyhydric alcohol aryl ethers, nitrogen-containing heterocyclic compounds, amides, amines, and sulfur-containing compounds.

Specific examples of the water-soluble organic solvents include, but are not limited to, polyhydric alcohols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butanediol, triethylene glycol, polyethylene glycol, propylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butanetriol, 1,2,3-butanetriol, 2,2,4-trimethyl-1,3-pentanediol, and 3-methyl-1,3,5-pentanetriol; polyhydric alcohol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether; polyhydric alcohol aryl ethers such as ethylene glycol monophenyl ether and ethylene glycol monobenzyl ether; nitrogen-containing heterocyclic compounds such as 2-pyrrolidone, N-methyl-2-pyrrolidone, N-hydroxyethyl-2-pyrrolidone, 1,3-dimethyl-2-imidazolidinone, ε-caprolactam, and γ-butyrolactone; amides such as formamide, N-methylformamide, N,N-dimethylformamide, 3-methoxy-N,N-dimethylpropionamide, and 3-butoxy-N,N-dimethylpropionamide; amines such as monoethanolamine, diethanolamine, and triethylamine; sulfur-containing compounds such as dimethyl sulfoxide, sulfolane, and thiodiethanol; propylene carbonate; and ethylene carbonate.

It is preferable to use an organic solvent having a boiling point of 250° C. or less, because such the organic solvent not only functions as a wetting agent, but also provides good drying properties.

The content of the organic solvent in the ink is not particularly limited, and can be selected as appropriate according to the intended purpose. However, from the perspective of the drying properties and ejection reliability of the ink, the content is preferably 10% by mass or more and 60% by mass or less, and more preferably 20% by mass or more and 60% by mass or less.

### —Water—

The water content in the ink is not particularly limited, and can be selected as appropriate according to the intended purpose. However, from the perspective of the drying properties and ejection reliability of the ink, the content is preferably 10% by mass or more and 90% by mass or less, and more preferably 20% by mass or more and 60% by mass or less.

### <Drying Step>

In the drying step S2, the fiber sheet, which has the predetermined region impregnated with the ink, is dried. In the drying step, the resin emulsion serving as the soft material becomes a gel state. More specifically, in the patterning step, the resin emulsion serving as the soft material is patterned on the fiber sheet. However, in the drying step, the resin emulsion is dried to form a resin film on the fiber sheet as the soft material. Therefore, the viscosity of the soft material becomes higher in the drying step than in the patterning step. Moreover, in the drying step, the soft material and the crosslinking agent do not react, and a crosslinked structure is not formed.

The drying method is not particularly limited as long as the method is capable of removing the solvent included in the ink that has impregnated the fiber sheet, and known methods can be used. Examples of the drying method include, but are not limited to, methods that use a hot air drying machine or a vacuum drying machine.

The drying temperature is not particularly limited, and is a temperature under which the crosslinking reaction does not proceed. From the perspective of the filling properties in the molding step, the temperature is preferably 100° C. or higher and 180° C. or lower, and more preferably 150° C. or higher and 180° C. or lower.

### <Application Step>

In the application step S3, a matrix resin is applied onto the patterned fiber sheet to obtain a fiber reinforced resin composite.

The application method is not particularly limited as long as the method is capable of applying the matrix resin onto the patterned fiber sheet, and can be selected as appropriate according to the intended purpose. The matrix resin may also be applied manually.

### [Matrix Resin]

The matrix resin refers to a resin in the fiber reinforced resin composite that is different from the soft material in the soft resin composition.

The melting point of the matrix resin is not particularly limited, and can be selected as appropriate according to the intended purpose, but the melting point is preferably 265° C. or lower, and 250° C. or lower. A melting point of 265° C. or lower is preferable in that the fiber sheet can be uniformly filled with both the matrix resin and the soft resin composition.

The type of matrix resin is not particularly limited, and can be selected as appropriate according to the intended purpose, and examples thereof include polyamide resins, urethane resins, polyester resins, acrylic resins, vinyl acetate resins, styrene resins, butadiene resins, styrene-butadiene resins, vinyl chloride resins, acrylic styrene resins, and acrylic silicone resins. Among such resins, polyamide resins are preferable. A single type of matrix resin may be used alone, or a combination of two or more matrix resins may be used.

### <Lamination Step>

In the lamination step S4, the fiber reinforced resin composite is laminated in a plurality of layers. A fiber reinforced resin composite having a desired thickness can be obtained by changing the number of the layers of the fiber reinforced resin composite that are laminated.

The lamination method is not particularly limited as long as the method is capable of laminating the fiber reinforced resin composite in a plurality of layers, and can be selected as appropriate according to the intended purpose.

### <Molding Step>

In the molding step S5, the fiber reinforced resin composite is molded to obtain a fiber reinforced resin composite molded article.

The molding is performed, for example, by applying heat, pressure, and the like.

The soft material and the crosslinking agent included in the soft resin composition react by application of heat and pressure in the molding step, which forms a crosslinked structure. For example, in the drying step, because a resin film is formed on the fiber sheet as the soft material, a crosslinked structure is formed due to a reaction between the resin film and the crosslinking agent. The inside of the fiber sheet is filled with the soft material and the matrix resin as a result of the molding step.

The molding conditions of the molding step can be selected as appropriate according to the reactivity between the soft material and the crosslinking agent included in the soft resin composition.

The molding method is not particularly limited as long as the reaction between the soft material and the crosslinking agent included in the soft resin composition proceeds as a result of applying heat and pressure, and known methods can be used. Examples of the molding method include, but are not limited to, methods that use a heat press machine.

### (Fiber Reinforced Resin Molded Article Manufacturing System)

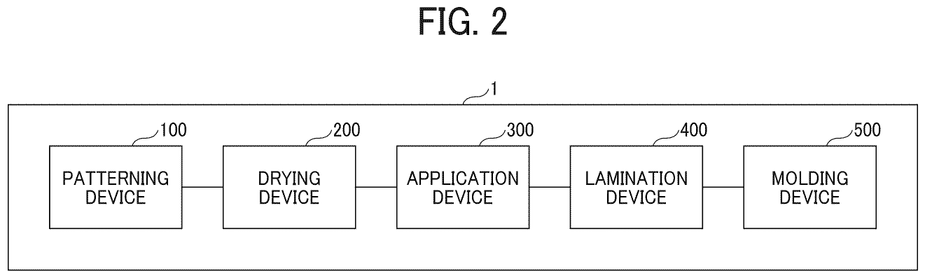

FIG. 2 is a schematic diagram illustrating a fiber reinforced resin molded article manufacturing system according to an embodiment of the present invention.

The fiber reinforced resin molded article manufacturing system 1 according to an example of the present invention includes a patterning device 100, a drying device 200, an application device 300, a lamination device 400, and a molding device 500.

The patterning device 100 performs the patterning step, which patterns the fiber sheet with the ink including the soft resin composition, which at least comprises the soft material. As the patterning device, for example, an inkjet printer (IPSiO GX e5500, manufactured by Ricoh Co., Ltd.) can be preferably used.

The drying device 200 performs the drying step, which dries the fiber sheet. As the drying device, a hot air drying machine or a vacuum drying machine that is typically used can be preferably used.

The application device 300 performs the application step, in which the matrix resin is applied onto the patterned fiber sheet to obtain the fiber reinforced resin composite. As the application device, for example, an electromagnetic feeder (manufactured by Sinfonia Technology Co., Ltd.) can be preferably used.

The lamination device 400 performs the lamination step, in which the fiber reinforced resin composite is laminated in a plurality of layers.

The molding device 500 performs the molding step, in which the fiber reinforced resin composite is molded to obtain the fiber reinforced resin molded article. As the molding device, for example, a heat press machine (manufactured by Sintokogio Co., Ltd.) can be preferably used.

### (Fiber Reinforced Resin Molded Article)

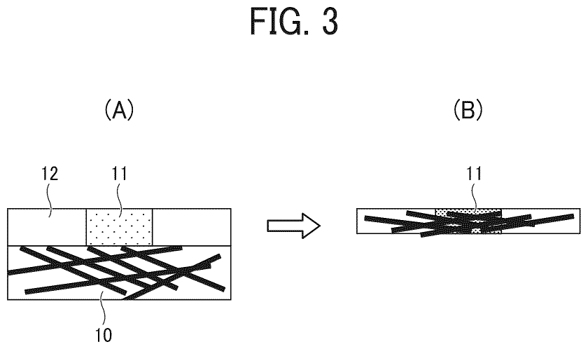

FIG. 3 is a schematic diagram illustrating a change before and after the molding step of the manufacturing method of a fiber reinforced resin molded article according to an embodiment of the present invention. A state (A) illustrates a fiber reinforced resin composite before the molding step, and a state (B) illustrates the fiber reinforced resin molded article after the molding step.

The state (A) is a state where the soft resin composition 11 and the matrix resin 12 are arranged on the fiber sheet 10. Before the molding step, the soft material and the crosslinking agent included in the soft resin composition 11 have not reacted, and are in a non-crosslinked state. That is, the inside of the fiber sheet 10 has not been filled with the soft resin composition 11 and the matrix resin 12.

On the other hand, in the state (B), the inside of the fiber sheet 10 is filled with the soft resin composition 11 and the matrix resin 12. As a result of the molding performed in the molding step, the inside of the fiber sheet 10 has been filled with the soft material and the matrix resin 12. At the same time, the reaction with the crosslinking agent proceeds, resulting in crosslinking. As a result of the inside of the fiber sheet 10 filled with the soft material, the strength of the obtained fiber reinforced resin molded article is improved. Furthermore, by adjusting the region that is impregnated with ink in the patterning step, the physical properties, such as the strength and impact resistance of the fiber reinforced resin molded article, can be adjusted. In addition, the state (B) is a fiber reinforced resin molded article in which the soft material is arranged in a predetermined region of the fiber sheet 10, and the matrix resin 12 is arranged outside the predetermined region, and the bending strength of the fiber reinforced resin molded article is 1 N/mm² or more.

Note that FIG. 3 is a state where the soft resin composition 11 is arranged in a center portion as the predetermined region on the fiber sheet 10, and the matrix resin 12 is arranged on both ends excluding the center portion on the fiber sheet 10. In addition, the soft resin composition 11 may be arranged on both ends as the predetermined region on the fiber sheet 10, and the matrix resin 12 is arranged on the center portion excluding both ends on the fiber sheet 10.

### EXAMPLES

Embodiments of the present invention will be described below by way of examples. However, the present invention is in no way limited to these examples. Note that, in the examples, “parts” represents “parts by mass,” unless otherwise specified.

### Preparation Example 1

### —Preparation of Ink 1—

An acetate buffer solution was adjusted in advance to pH 4.0 using ion-exchanged water, acetic acid, and sodium acetate.

In a homomixer were emulsified 41.0 parts by mass of methyl methacrylate (MMA) and 51.5 parts by mass of 2-ethylhexyl acrylate (EHA) as raw materials of the soft material, 7.5 parts by mass of vinyltriethoxysilane (VTES) as the crosslinking agent, 0.2 parts by mass of 1-octanethiol (NOM) as the chain transfer agent, 1.8 parts by mass of an aqueous solution of polyoxyethylene nonylpropenyl phenyl ether ammonium sulfate (AR-10 (manufactured by Daiichi Kogyo Seiyaku Co., Ltd.)) as the emulsifier, and 50.0 parts by mass of the acetate buffer solution, resulting in a uniform, milky white emulsion.

A 1 L flask equipped with a stirrer, a thermometer, a nitrogen gas inlet tube, and a reflux condenser was charged with 87.0 parts by mass of the acetate buffer solution, and the temperature was raised to 70° C. while introducing nitrogen.

Then, 2.8 parts by mass of a 10% by mass aqueous polyoxyethylene styrenated propenyl phenyl ether ammonium sulfate (AQUALON AR-10 (manufactured by Daiichi Kogyo Seiyaku Co., Ltd.)) solution was added as the emulsifier, and 2.6 parts by mass of a 5% by mass aqueous ammonium persulfate solution (APS) was added as the polymerization initiator. The emulsion was then added dropwise continuously over a period of 2.5 hours. Also, 0.6 parts by mass of a 5% by mass aqueous ammonium persulfate solution was added every hour from the start of the dropwise addition until 3 hours had elapsed. After completion of the dropwise addition, the mixture was aged at 70° C. for 2 hours, and then cooled to obtain a resin particle dispersion.

Then, 50 parts by mass of the obtained resin particle dispersion and 50 parts by mass of propylene glycol as a solvent were mixed and stirred.

Thereafter, the mixture was filtered under pressure using a cellulose acetate membrane filter having an average pore size of 0.8 μm to remove coarse particles, and ink 1 was obtained.

### Preparation Example 2

### —Preparation of Ink 2—

Ink 2 was obtained in the same manner as in Preparation Example 1, except that the addition amount of 2-ethylhexyl acrylate in Preparation Example 1 was changed to 54.0 parts by mass, and the addition amount of vinyltriethoxysilane was changed to 5.0 parts by mass.

### Preparation Example 3

### —Preparation of Ink 3—

Ink 3 was obtained in the same manner as in Preparation Example 1, except that the addition amount of 2-ethylhexyl acrylate in Preparation Example 1 was changed to 49.0 parts by mass, and the addition amount of vinyltriethoxysilane was changed to 10.0 parts by mass.

### Preparation Example 4

### —Preparation of Ink 4—

Ink 4 was obtained in the same manner as in Preparation Example 1, except that the vinyltriethoxysilane in Preparation Example 1 was changed to vinyltrimethoxysilane.

### Preparation Example 5

### —Preparation of Ink 5—

Ink 5 was obtained in the same manner as in Preparation Example 2, except that the vinyltriethoxysilane in Preparation Example 2 was changed to vinyltrimethoxysilane.

### Preparation Example 6

### —Preparation of Ink 6—

Ink 6 was obtained in the same manner as in Preparation Example 3, except that the vinyltriethoxysilane in Preparation Example 3 was changed to vinyltrimethoxysilane (VTMS).

### Preparation Example 7

### —Preparation of Ink 7—

In a homomixer were emulsified 41.0 parts by mass of methyl methacrylate and 51.5 parts by mass of 2-ethylhexyl acrylate as raw materials of the soft material, 7.5 parts by mass of vinyltriethoxysilane as the crosslinking agent, 0.2 parts by mass of 1-octanethiol as the chain transfer agent, 1.8 parts by mass of an aqueous solution of polyoxyethylene nonylpropenyl phenyl ether ammonium sulfate (Aqualon AR-10 (manufactured by Daiichi Kogyo Seiyaku Co., Ltd.)) as the emulsifier, and 50.0 parts by mass of ion-exchanged water as the solvent, resulting in a uniform, milky white emulsion.

A 1 L flask equipped with a stirrer, a thermometer, a nitrogen gas inlet tube, and a reflux condenser was charged with 87.0 parts by mass of ion-exchanged water, and the temperature was raised to 70° C. while introducing nitrogen.

Then, after adding 2.8 parts by mass of a 10% by mass aqueous AQUALON HS-10 (manufactured by Daiichi Kogyo Seiyaku Co., Ltd.) solution as the emulsifier, and 2.6 parts by mass of a 5% by mass aqueous ammonium persulfate solution as the initiator, the emulsion was added dropwise continuously over a period of 2.5 hours. Also, 0.6 parts by mass of a 5% by mass aqueous ammonium persulfate solution was added every hour from the start of the dropwise addition until 3 hours had elapsed.

After completion of the dropwise addition, the mixture was aged at 70° C. for 2 hours, and then cooled to obtain a resin particle dispersion.

Then, 50 parts by mass of the obtained resin particle dispersion and 50 parts by mass of propylene glycol as a solvent were mixed and stirred.

Thereafter, the mixture was filtered under pressure using a cellulose acetate membrane filter having an average pore size of 0.8 μm to remove coarse particles, and ink 7 was obtained.

### Preparation Example 8

### —Preparation of Ink 8—

Ink 8 was obtained in the same manner as in Preparation Example 7, except that the vinyltriethoxysilane serving as the crosslinking agent in Preparation Example 7 was changed to vinyltrimethoxysilane.

### Preparation Example 9

### —Preparation of Ink 9—

Ink 9 was obtained in the same manner as in Preparation Example 7, except that the vinyltriethoxysilane serving as the crosslinking agent in Preparation Example 7 was changed to 1,6-hexanediol dimethacrylate.

### Preparation Example 10

### —Preparation of Ink 10—

Ink 10 was obtained in the same manner as in Preparation Example 9, except that, as raw materials of the soft material in Preparation Example 9, the addition amount of 2-ethylhexyl acrylate was changed to 54.0 parts by mass, and the addition amount of 1,6-hexanediol dimethacrylate was changed to 5.0 parts by mass.

### Preparation Example 11

### —Preparation of Ink 11—

Ink 11 was obtained in the same manner as in Preparation Example 9, except that, as raw materials of the soft material in Preparation Example 9, the addition amount of 2-ethylhexyl acrylate was changed to 49.0 parts by mass, and the addition amount of 1,6-hexanediol dimethacrylate was changed to 10.0 parts by mass.

### Example 1

### —Preparation of Fiber Reinforced Resin Molded Article 1—

In the patterning step, an inkjet printer [patterning device] (IPSiO GX e5500, manufactured by Ricoh Co., Ltd.) was used to apply ink 1 to a center portion on a carbon fiber sheet (100 mm×100 mm carbon fiber nonwoven fabric, manufactured by Takayasu Co., Ltd.). Next, in the drying step, the carbon fiber sheet on which ink 1 had been applied was dried at 120° C. for 40 minutes using a drying machine (manufactured by Yamato Scientific Co., Ltd.). Then, in the application step, a polyamide resin (PA2200, manufactured by EOS GmbH) was applied as a matrix resin using an electromagnetic feeder (manufactured by Sinfonia Technology Co., Ltd.) to both ends of the carbon fiber sheet excluding the center portion on which ink 1 had been applied, to obtain a fiber reinforced resin composite. Thereafter, in the lamination step, 22 sheets of the fiber reinforced resin composite were laminated by hand.

In the molding step, the laminated fiber reinforced resin composites were heated and pressurized for 300 seconds at a temperature of 200° C. and a load of 2.5 kN using a heat press machine (manufactured by Shinto Kogyo Co., Ltd.), and then water-cooled while maintaining the load of 2.5 kN. The upper and lower heating plates of the heat press machine were cooled with water to 45° C., and the pressure was then released to obtain the fiber reinforced resin molded article 1.

### Examples 2 to 11

### —Preparation of Fiber Reinforced Resin Molded Articles 2 to 11—

Except for changing the ink used in Example 1 to the inks listed in Table 1, the fiber reinforced resin molded articles 2 to 11 were obtained in the same manner as in Example 1.

### Comparative Examples 1 and 2

### —Preparation of Fiber Reinforced Resin Molded Article 12—

The patterning step and the drying step were omitted. In the application step, a polyamide resin (PA2200, manufactured by EOS GmbH) was applied as the matrix resin using an electromagnetic feeder (manufactured by Sinfonia Technology Co., Ltd.) to the entire surface of a carbon fiber sheet (100 mm×100 mm carbon fiber nonwoven fabric, manufactured by Takayasu Co., Ltd.). The lamination step and the molding step were performed in the same manner as in Example 1 to obtain the fiber reinforced resin molded article 12.

### —Preparation of Fiber Reinforced Resin Molded Article 13—

In the patterning step, an inkjet printer (manufactured by Ricoh Co., Ltd.) was used to apply ink 1 to the entire surface of a carbon fiber sheet (100 mm×100 mm carbon fiber nonwoven fabric, manufactured by Takayasu Co., Ltd.). In the application step, a polyamide resin (PA2200, manufactured by EOS GmbH) was applied as the matrix resin using an electromagnetic feeder (manufactured by Sinfonia Technology Co., Ltd.) to the entire surface of the carbon fiber sheet, on which ink 1 had been applied. The drying step, the lamination step, and the molding step were performed in the same manner as in Example 1 to obtain the fiber reinforced resin molded article 13.

For the fiber reinforced resin molded articles 1 to 13 obtained in Examples 1 to 11 and Comparative Examples 1 and 2, the filling properties of the ink and the bending strength of the molded articles were evaluated in order to confirm the degree of design freedom. The evaluation results are presented in Table 1. If 80% or more of the ink is filled, the degree of design freedom can be ensured because the soft material can be sufficiently arranged in the target area. Further, if the bending strength of the molded article is 1 N/mm² or more, the degree of design freedom can be ensured because the strength is sufficient for practical use.

### <Filling Properties of Soft Material>

The fiber reinforced resin molded articles were observed under an optical microscope, and the area ratio occupied by the soft material was evaluated as the filling rate of the soft material in the carbon fiber sheet.

### [Evaluation Criteria]

Excellent: Filling rate of 90% or more
Good: Filling rate of less than 80% or more and less than 90%
Poor: Filling rate of less than 80%<

### <Bending Strength of Molded Article>

The fiber reinforced resin molded article (thickness 1 mm) was cut into a size of 75 mm×6 mm, and a three-point bending test was performed using a strength testing machine (AG-5kNX, manufactured by Shimadzu Corporation).

### [Evaluation Criteria]

Excellent: Bending strength of 5 N/mm² or more
Good: Bending strength of 1 N/mm² or more and 5 N/mm²
Poor: Bending strength of less than 1 N/mm²

TABLE 1

| | Ink | | | | |
|---|---|---|---|---|---|
| | | Patterning | Matrix resin | Filling properties | Bending strength of |
| | Type | region | application region | of soft material | molded article |
| Example 1 | Ink 1 | Center portion | Center portion excluded | Excellent | Excellent |
| Example 2 | Ink 2 | Center portion | Center portion excluded | Excellent | Good |
| Example 3 | Ink 3 | Center portion | Center portion excluded | Good | Excellent |
| Example 4 | Ink 4 | Center portion | Center portion excluded | Excellent | Excellent |
| Example 5 | Ink 5 | Center portion | Center portion excluded | Excellent | Good |
| Example 6 | Ink 6 | Center portion | Center portion excluded | Good | Excellent |
| Example 7 | Ink 7 | Center portion | Center portion excluded | Good | Excellent |
| Example 8 | Ink 8 | Center portion | Center portion excluded | Good | Excellent |
| Example 9 | Ink 9 | Center portion | Center portion excluded | Good | Good |
| Example 10 | Ink 10 | Center portion | Center portion excluded | Good | Good |
| Example 11 | Ink 11 | Center portion | Center portion excluded | Good | Good |
| Comparative | — | — | Entire surface | Poor | Poor |
| Example 1 | | | | | |
| Comparative | Ink 1 | Entire surface | Entire surface | Could not be | Poor |
| Example 2 | | | | observed | |

The fiber reinforced resin molded articles of Examples 1 to 11 were each filled with 80% or more of the soft material, and had a bending strength of 1 N/mm² or more. Therefore, by adjusting the pattern arrangement of the soft material, it is possible to arrange the soft material in a target area, and ensure sufficient strength for practical use. Therefore, the fiber reinforced resin molded article has a high degree of design freedom.

On the other hand, as illustrated in Comparative Example 1, the strength of the fiber reinforced resin molded article obtained when the soft material is not applied is not sufficient. Furthermore, as illustrated in Comparative Example 2, in the case where the soft material and the matrix resin are applied to the entire surface of the fiber sheet without a pattern arrangement of the soft material, the strength of the obtained fiber reinforced resin molded article is not sufficient.

For example, aspects of the present invention include the following.

A first aspect is a method of manufacturing a fiber reinforced resin molded article. The method includes:
patterning a fiber sheet with an ink including a soft resin composition that at least comprises a soft material;
applying a matrix resin onto the patterned fiber sheet to obtain a fiber reinforced resin composite; and
molding the fiber reinforced resin composite to obtain a fiber reinforced resin molded article, in which
an interior of the fiber sheet in the fiber reinforced resin molded article is filled with the soft material and the matrix resin.

A second aspect is the method according to the first aspect, in which the patterning includes patterning a predetermined region of the fiber sheet, and the applying includes applying the matrix resin to a region that is different from the predetermined region.

A third aspect is the method according to the first or second aspect, further including laminating the fiber reinforced resin composite in a plurality of layers.

A fourth aspect is the method according to any one of the first to third aspects, further including drying the fiber sheet before the applying.

A fifth aspect is the method according to any one of the first to fourth aspects, in which the soft material is a resin emulsion.

A sixth aspect is the method according to any one of the first to fifth aspects, in which the soft resin composition includes a crosslinking agent, and the crosslinking agent is an alkoxysilane-based crosslinking agent.

A seventh aspect is the method according to any one of the first to sixth aspects, in which the soft resin composition includes a crosslinking agent, and a content of the crosslinking agent in the soft resin composition is 5% by mass or more and 10% by mass or less.

An eighth aspect is the method according to any one of the first to seventh aspects, in which the fiber sheet includes glass fiber or carbon fiber.

A ninth aspect is the method according to any one of the first to eighth aspects, in which the matrix resin has a melting point of 265° C. or lower.

A tenth aspect is a fiber reinforced resin molded article manufacturing system including:
a patterning device that patterns a fiber sheet with an ink including a soft resin composition that at least comprises a soft material;
a drying device that dries the fiber sheet;
an application device that applies a matrix resin onto the patterned fiber sheet to obtain a fiber reinforced resin composite;
a lamination device that laminates the fiber reinforced resin composite in a plurality of layers to obtain a laminate; and
a molding device that molds the laminate to obtain a fiber reinforced resin molded article, in which
an interior of the fiber sheet in the fiber reinforced resin molded article is filled with the soft material and the matrix resin.

An eleventh aspect is a fiber reinforced resin molded article including a biner sheet, a soft material arranged in a predetermined region on the fiber sheet, a matrix resin arranged in a region different from the predetermined region, in which the fiber reinforced resin molded article has a bending strength of 1 N/mm² or more.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A method of manufacturing a fiber reinforced resin molded article, the method comprising:
patterning a fiber sheet with an ink including a soft resin composition that at least comprises a soft material;
applying a matrix resin onto the patterned fiber sheet to obtain a fiber reinforced resin composite; and
molding the fiber reinforced resin composite to obtain a fiber reinforced resin molded article, wherein
an interior of the fiber sheet in the fiber reinforced resin molded article is filled with the soft material and the matrix resin.

2. The method according to claim 1, wherein
the patterning includes patterning a predetermined region of the fiber sheet, and
the applying includes applying the matrix resin to a region that is different from the predetermined region.

3. The method according to claim 1, further comprising:
laminating the fiber reinforced resin composite in a plurality of layers.

4. The method according to claim 1, further comprising:
drying the fiber sheet before the applying.

5. The method according to claim 1, wherein
the soft material is a resin emulsion.

6. The method according to claim 1, wherein
the soft resin composition includes a crosslinking agent, and
the crosslinking agent is an alkoxysilane-based crosslinking agent.

7. The method according to claim 1, wherein
the soft resin composition includes a crosslinking agent, and
a content of the crosslinking agent in the soft resin composition is 5% by mass or more and 10% by mass or less.

8. The method according to claim 1, wherein
the fiber sheet includes glass fiber or carbon fiber.

9. The method according to claim 1, wherein
the matrix resin has a melting point of 265° C. or lower.

10. A fiber reinforced resin molded article manufacturing system comprising:
a patterning device that patterns a fiber sheet with an ink including a soft resin composition that at least comprises a soft material;
a drying device that dries the fiber sheet;
an application device that applies a matrix resin onto the patterned fiber sheet to obtain a fiber reinforced resin composite;
a lamination device that laminates the fiber reinforced resin composite in a plurality of layers to obtain a laminate; and
a molding device that molds the laminate to obtain a fiber reinforced resin molded article, wherein
an interior of the fiber sheet in the fiber reinforced resin molded article is filled with the soft material and the matrix resin.

11. A fiber reinforced resin molded article comprising:
a fiber sheet;
a soft material arranged in a predetermined region on the fiber sheet; and
a matrix resin arranged in a region different from the predetermined region, wherein the fiber reinforced resin molded article has a bending strength of 1 N/mm² or more.
